(19) United States
(12) Patent Application Publication
(10) Pub. No.: US 2015/0070256 A1
(43) Pub. Date: Mar. 12, 2015

(54) FIELD SEQUENTIAL COLOR DISPLAY

(71) Applicants: Jing Gu, Shanghai (CN); XIXI Lou, (US)

(72) Inventors: Jing Gu, Shanghai (CN); XIXI Lou, (US)

(73) Assignee: SHENZHEN YUNYINGGU TECHNOLOGY CO., LTD, SHENZHEN (CN)

(21) Appl. No.: 14/397,320

(22) PCT Filed: Jul. 20, 2012
(86) PCT No.: PCT/CN2012/078940

§ 371 Date: Oct. 27, 2014

(51) Int. Cl. G09G 3/34; G09G 3/36

(52) U.S. Cl. CPC G09G 3/3413; G09G 3/3611
USPC 345/88; 345/102

(57) ABSTRACT

An apparatus includes control logic and a scan driving unit. The control logic is configured to control driving of a display panel having an array of pixels divided into groups of pixels. Each group of pixies includes rows of pixels. The control logic is configured to control sequentially applying of multiple backlights having different colors to the array of pixels in multiple time periods. The scan driving unit is operatively coupled to the control logic and is configured to, in each time period, scan the rows of pixels of each group of pixels according to a row scanning sequence. For each group of pixels, in a first time period, the scan driving unit sequentially scans the rows of pixels according to a first row scanning sequence; in a second time period, the scan driving unit sequentially scans the rows of pixels according to a second row scanning sequence.

### BACKGROUND

The disclosure relates generally to displays, and more particularly, to field sequential color (FSC) displays.

FSC display is one type of displays in which the primary color information, e.g., red (R), green (G), and blue (B), is transmitted in successive images, and which relies on the human vision system to fuse the successive images into a color picture. FSC displays, such as FSC liquid color displays (LCDs), offers two important advantages over the color filters-based displays: its optical efficiency is improved by up to three times, and the device resolution is improved by three times.

On the other hand, the refresh rate (field frequency) of FSC displays is also much higher, e.g., three times higher, than that of the color filters-based displays in order to render the same color information. Thus, a major challenge for FSC LCDs is the need for fast liquid crystal (LC) setting time in order to suppress color breakup caused by the high refresh rate. As resolution of displays increases, the available LC setting time is further suppressed. The above-mentioned problem is further exacerbated, in particular, at the one or more rows of pixels that are scanned at the end of each sub frame (field), e.g., the bottom row(s) of pixels, because the LCs of those pixels may not have enough setting time before the backlight is applied. Known solutions to reduce color breakup, such as increasing field frequency, inserting another color or black field, or motion compensation, all require fast LC setting time. Some of them even sacrifice the display brightness or are restricted by the uncertainty of observer's motion.

Accordingly, there exists a need for improved FSC displays to solve the above-mentioned problems.

### BRIEF DESCRIPTION OF THE DRAWINGS

The embodiments will be more readily understood in view of the following description when accompanied by the below figures and wherein like reference numerals represent like elements, wherein:

FIG. 1 is a block diagram illustrating an apparatus including a display in accordance with one embodiment set forth in the disclosure;

FIG. 2 is a side-view diagram illustrating one example of the display of the apparatus shown in FIG. 1 in accordance with one embodiment set forth in the disclosure;

FIG. 3 is a plan-view diagram illustrating one example of the display of the apparatus shown in FIG. 1 in accordance with one embodiment set forth in the disclosure;

FIG. 4 is a plan-view diagram illustrating another example of the display of the apparatus shown in FIG. 1 in accordance with one embodiment set forth in the disclosure;

FIGS. 5-7 are depictions of pixel groups divided from an array of pixels on a display panel in accordance with different embodiments set forth in the disclosure;

FIG. 8 is a depiction of a plurality of pixel groups scanned according to row/group scanning sequences in a plurality of sub frames in accordance with one embodiment set forth in the disclosure;

FIGS. 9-13 are depictions of row scanning sequences for scanning rows of pixels in each pixel group in accordance with different embodiments set forth in the disclosure;

FIGS. 14-15 are depictions of group scanning sequences for scanning pixel groups in accordance with different embodiments set forth in the disclosure;

FIG. 16 is a flow chart illustrating one example of a method for driving the display of the apparatus shown in FIG. 1 in accordance with one embodiment set forth in the disclosure; and

FIG. 17 is a flow chart illustrating another example of a method for driving the display of the apparatus shown in FIG. 1 in accordance with one embodiment set forth in the disclosure.

### SUMMARY

The present disclosure describes apparatus and method for driving field sequential color (FSC) displays. In one example, an apparatus including control logic and a scan driving unit is provided. The control logic is configured to control driving of a display panel having an array of pixels divided into one or more groups of pixels. Each group of pixels includes one or more rows of pixels. The control logic is also configured to control sequentially applying of a plurality of backlights having different colors to the array of pixels in a plurality of time periods. The scan driving unit is operatively coupled to the control logic and is configured to, in each time period, scan the one or more rows of pixels of each group of pixels according to a row scanning sequence. For each group of pixels, in a first time period, the scan driving unit sequentially scans the one or more rows of pixels according to a first row scanning sequence; in a second time period, the scan driving unit sequentially scans the one or more rows of pixels according to a second row scanning sequence.

In another example, an apparatus including a display panel, control logic, a backlight driving unit, a scan driving unit, and a data driving unit is provided. The display panel has an array of pixels divided into one or more groups of pixel. Each group of pixels includes one or more rows of pixels. The control logic is configured to receive display data and provide control signals based on the display data. The backlight driving unit is operatively coupled to the control logic and is configured to sequentially apply a plurality of backlights having different colors to the array of pixels in a plurality of time periods based on the control signals. The scan driving unit is operatively coupled to the control logic and is configured to, in each time period, scan the one or more rows of pixels of each group of pixels according to a row scanning sequence based on the control signals. The data driving unit is operatively coupled to the control logic and is configured to, in each time period, write the display data into the array of pixels based on the control signals. For each group of pixels, in a first time period, the scan driving unit sequentially scans the one or more rows of pixels according to a first row scanning sequence; in a second time period, the scan driving unit sequentially scans the one or more rows of pixels according to a second row scanning sequence.

A method for driving a display panel is also provided. The display panel has an array of pixels divided into one or more groups of pixels. Each group of pixels includes one or more rows of pixels. In one example, display data is received. Control signals are provided based on the display data. The one or more rows of pixels of each group of pixels are scanned according to a row scanning sequence based on the control signals. The display data is written into the array of pixels based on the control signals. A plurality of backlights having different colors are sequentially applied to the array of pixels in a plurality of time periods based on the control signals. For each group of pixels, in a first time period, the scan driving unit sequentially scans the one or more rows of pixels according to a first row scanning sequence; in a second time period, the scan driving unit sequentially scans the one or more rows of pixels according to a second row scanning sequence.

Among other advantages, the present disclosure provides an effective way to suppress color breakup, in particular, for FSC displays with high resolutions, thereby improving user experience. By introducing novel row/group scanning sequences, the apparatus and method disclosed herein can reduce color breakup without increasing LC setting speed or sacrificing display brightness. Compared with known solutions, the apparatus and method disclosed herein are more cost-effective and flexible.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### DETAILED DESCRIPTION

In the following detailed description, numerous specific details are set forth by way of examples in order to provide a thorough understanding of the relevant disclosures. However, it should be apparent to those skilled in the art that the present disclosure may be practiced without such details. In other instances, well known methods, procedures, systems, components, and/or circuitry have been described at a relatively high-level, without detail, in order to avoid unnecessarily obscuring aspects of the present disclosure.

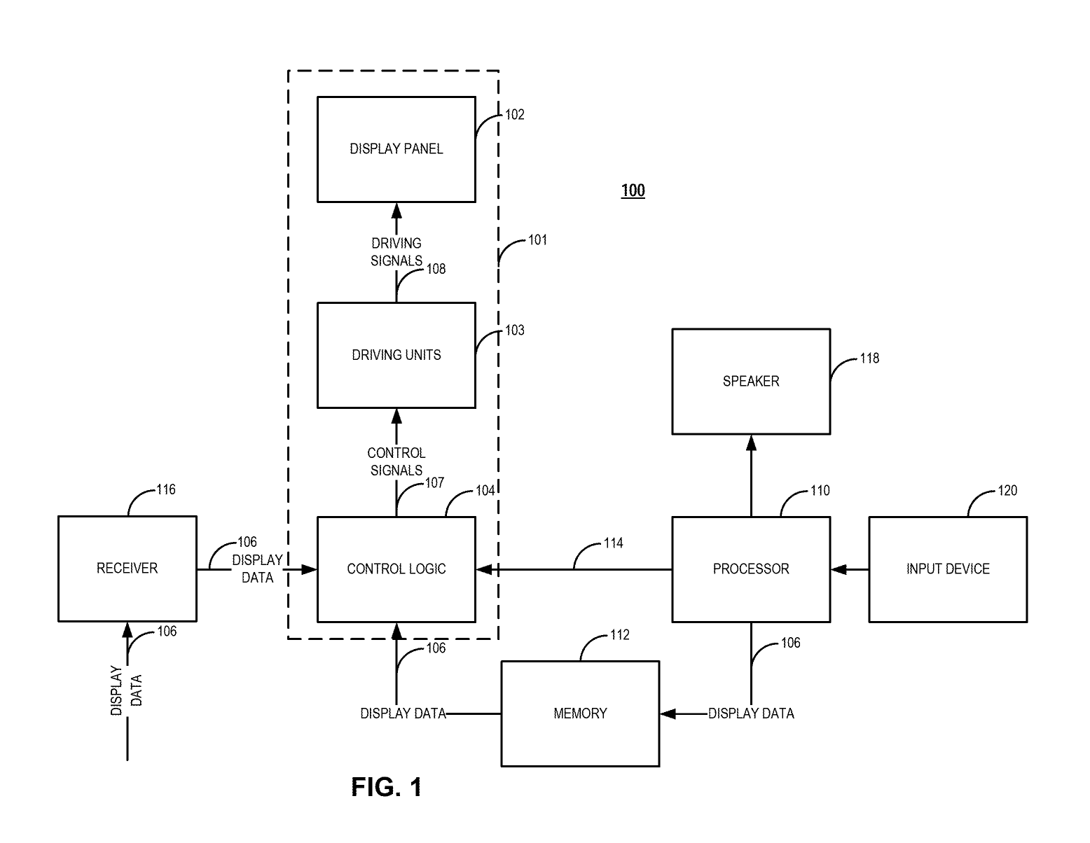

FIG. 1 illustrates an apparatus 100 including a display 101. The apparatus 100 may be any suitable device, for example, a television set, laptop computer, desktop computer, netbook computer, media center, handheld device (e.g., dumb or smart phone, tablet, etc.), global positioning system (GPS), electronic billboard, gaming console, set-top box, printer, or any other suitable device. In this example, the display 101 is operatively coupled to other components of the apparatus 100 and is part of the apparatus 100, such as but not limited to, a television screen, computer monitor, dashboard, head-mounted display, or electronic billboard. The display 101 may be a FSC display, such as a FSC LCD, FSC light-emitting diode (LED) display, or any other suitable type of display. The display 101 may include a display panel 102, one or more driving units 103, and control logic 104.

The control logic 104 of the display 101 may be a timing controller (TCON), or any suitable hardware, software, firmware, or combination thereof, configured to receive display data 106 and provide control signals 107 to the driving units 103 based on the received display data 106. The control signals 107 are used for controlling writing of pixels and directing operations of the display panel 102. The control logic 104 may include any other suitable components, including an encoder, a decoder, one or more processors, controllers, and storage devices. The driving units 103 in this example are configured to generate driving signals 108 based on the control signals 107 for directing operations of the display panel 102 by, e.g., writing pixels and applying backlights to the display panel 102. The driving units 103 may include one or more scan driving units (gate drivers), data driving units (source drivers), and backlight driving units. The display panel 102 has an array of pixels arranged in multiple rows and columns. In this example, the array of pixel is divided into one or more groups of pixels. Each group of pixels includes one or more rows of pixels.

In one example, the apparatus 100 may be a laptop or desktop computer having a display 101. In this example, the apparatus 100 also includes a processor 110 and memory 112. The processor 110 may be, for example, a graphic processor (e.g., GPU), a general processor (e.g., APU, accelerated processing unit; GPGPU, general-purpose computing on GPU), or any other suitable processor. The memory 112 may be, for example, a discrete frame buffer or a unified memory. The processor 110 is configured to generate display data 106 in display frames and temporally store the display data 106 in the memory 112 before sending it to the control logic 104. The processor 110 may also generate other data, such as but not limited to, control instructions 114 or test signals, and provide them to the control logic 104 directly or through the memory 112. The control logic 104 then receives the display data 106 from the memory 112 or from the processor 110 directly.

In another example, the apparatus 100 may be a television set having a display 101. In this example, the apparatus 100 also includes a receiver 116, such as but not limited to, an antenna, radio frequency receiver, digital signal tuner, digital display connectors, e.g., HDMI, DVI, DisplayPort, USB, Bluetooth, WiFi receiver, or Ethernet port. The receiver 116 is configured to receive display data 106 as an input of the apparatus 100 and provide the native or modulated display data 106 to the control logic 104.

In still another example, the apparatus 100 may be a handheld device, such as a smart phone or a tablet. In this example, the apparatus 100 includes the processor 110, memory 112, and receiver 116. The apparatus 100 may both generate display data 106 by its processor 110 and receive display data 106 through its receiver 116. For example, the apparatus 100 may be a handheld device that works as both a portable television and a portable computing device. In any event, the apparatus 100 at least includes the display 101 with an array of pixels divided into groups of pixels as described below in detail. The apparatus 100 may also include any other suitable component such as, but not limited to, a speaker 118 and an input device 120, e.g., a mouse, keyboard, remote controller, handwriting device, camera, microphone, scanner, etc.

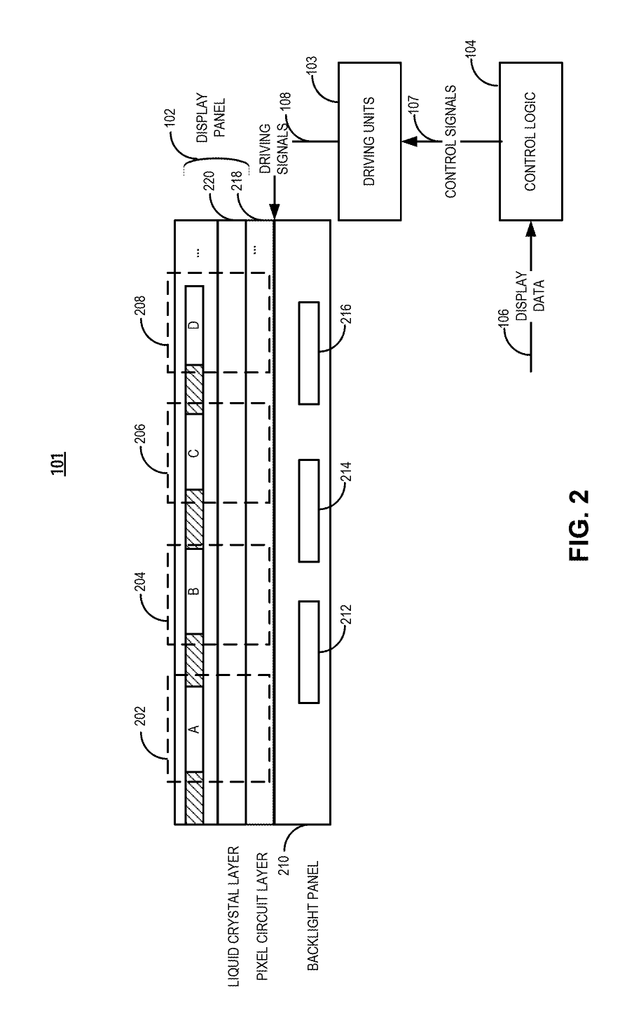

FIG. 2 illustrates one example of a side-view of the display 101 including an array of pixels 202, 204, 206, 208. The display 101 may be any suitable type of FSC displays, for example, a FSC LCD, such as a twisted nematic (TN) LCD, in-plane switching (IPS) LCD, advanced fringe field switching (AFFS) LCD, vertical alignment (VA) LCD, advanced super view (ASV) LCD, blue phase mode LCD, passive-matrix (PM) LCD, or any other suitable display. The display 101 may include the display panel 102 and a backlight panel 210, which are operatively coupled to the driving units 103. For FSC displays, the backlight panel 210 includes multiple light sources for sequentially providing backlights in different colors to the display panel 102 based on the driving signals 108 from the driving units 103, such as but not limited to, incandescent light bulbs, LEDs, electroluminescence (EL) panel, cold cathode fluorescent lamps (CCFLs), and hot cathode fluorescent lamps (HCFLs), to name a few. In this example, for FSC LCDs, the light sources may include a red (R) LED source 212, a green (G) LED source 214, and a blue (B) LED source 216. The light sources 212, 214, 216 are sequentially turned on at the end of each sub frame (field). It is understood that the color of the light sources is not limited to R, G, or B, and may include any other suitable colors, such as yellow (Y), cyan (C), magenta (M), or white (W). It is also understood that more than three light sources may be included in the backlight panel 210 for applying more than three colors of backlights to the display panel 102 in sequential sub frames.

The display panel 102 may be, for example, a TN panel, an IPS panel, an AFFS panel, a VA panel, an ASV panel, or any other suitable display panel. In this example, the display panel 102 includes a pixel circuit layer 218 and a liquid crystal (LC) layer 220. For FSC LCDs, color filters are not necessary for each pixel. Black matrix, as the borders of the pixels 202, 204, 206, 208, may be used for blocking lights coming out from the parts outside each pixel region. In this example, the pixel circuit layer 218 includes a plurality of pixel circuits, each having multiples thin film transistors (TFTs) and capacitors, corresponding to the plurality of pixels 202, 204, 206, 208, respectively. Each pixel circuit may be individually addressed by the driving signals 108 from the driving units 103 and is configured to drive the corresponding pixels 202, 204, 206, 208 by controlling light passing through the corresponding LC in each pixel. For example, the gate electrode of a TFT in each pixel circuit is coupled to one of the driving unit, i.e., the scan driving unit, and the source of the TFT is coupled to another driving unit, i.e., the data driving unit. The display panel 102 may include any other suitable component, such as one or more glass substrates, polarization layers, or a touch panel, as known in the art.

It is understood that the display 101 is not limited to a FSC LCD. In another example, the display 101 may be a LED display, such as a side-by-side organic LED (SBS OLED) display or white OLED display, i.e., white OLEDs with color filters (WOLED-CF). OLEDs with different colors may be sequentially activated in different color fields/sub frames based on the driving signals 108 from the driving units 103. For example, in the R sub frame, all the R OLEDs are turned-on while other OLEDs, e.g., G and B OLEDs are turned-off; in the G sub frame, all the G OLEDs are turned-on while other OLEDs, e.g., R and B OLEDs are turned-off; in the B sub frame, all the B OLEDs are turned-on while other OLEDs, e.g., R and G OLEDs are turned-off.

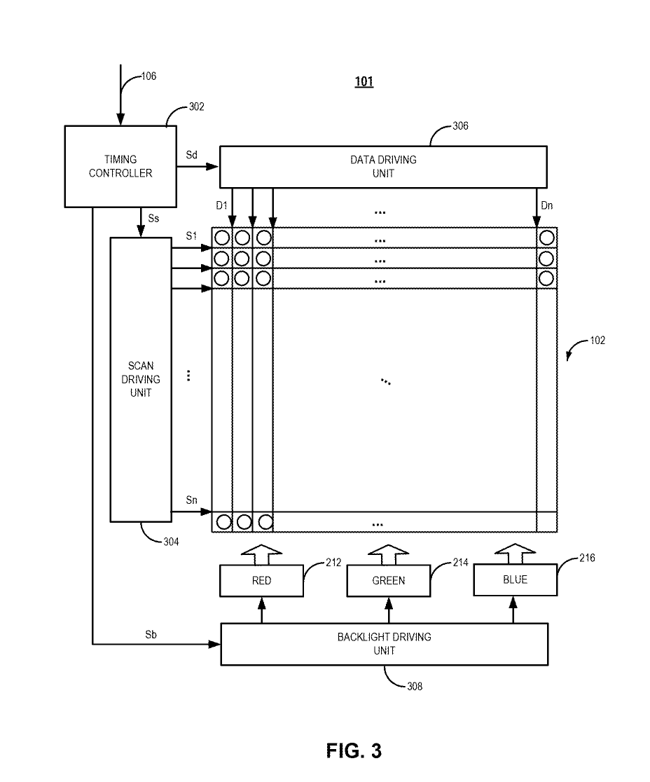

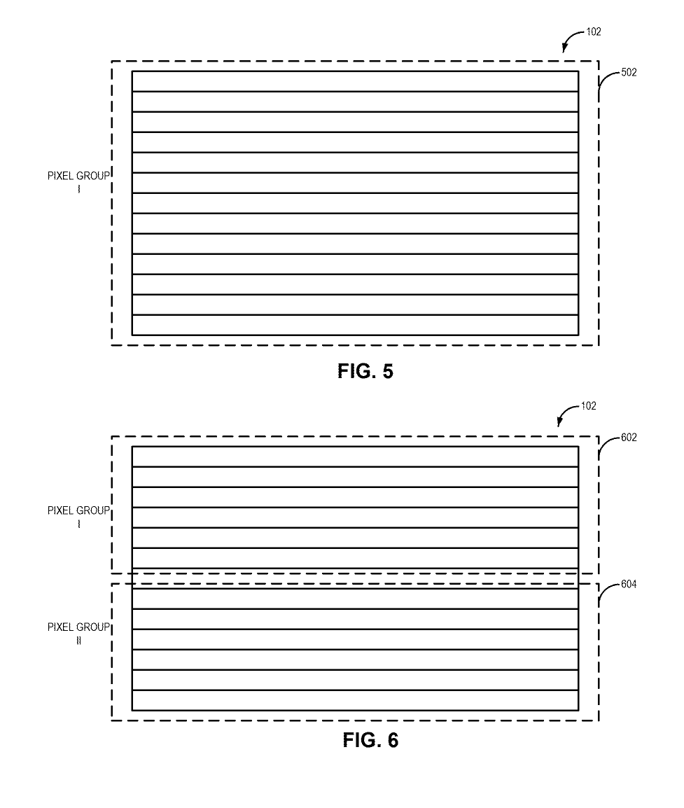

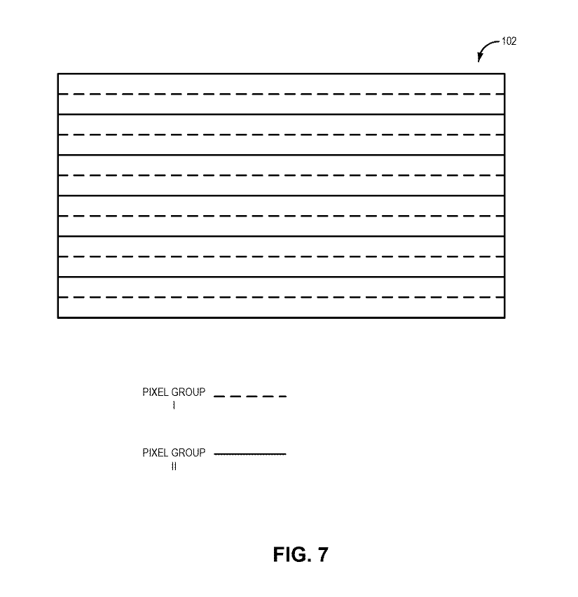

FIG. 3 is a plan-view diagram of one example of the display 101. The display panel 102 has an array of pixels arranged in multiple rows and columns. The array of pixels in this example is divided into one or more groups of pixels, each of which includes one or more rows of pixels. Now referring to FIGS. 5-7, different examples of pixel groups are disclosed in accordance with different embodiments of the present disclosure. In FIG. 5, the array of pixels is divided into one pixel group 502. In other words, all the rows of pixels on the display panel 102 may be considered as a single pixel group. In FIG. 6, the array of pixels is divided into a first pixel group 602 and a second pixel group 604 in the vertical direction. In one example, the numbers of rows in each pixel group 602, 604 are the same. That is, the array of pixels is evenly divided into two pixel groups that are adjacent to each other in the vertical direction. For example, for a display panel 102 has n rows of pixels, i.e., the vertical resolution of the display panel 102 is n, the first pixel group includes pixel row 1 through row 2/n, and the second pixel group includes pixel row (2/n)+1 to row n. It is understood that the number of pixel groups is not limited to two, and may be any number in other examples. For example, the n rows of pixels may be evenly divided into four pixels groups in the vertical direction, each of which includes 4/n rows of pixels. It is also understood that the pixel groups may be unevenly divided in other examples. For example, each pixel group may include different numbers of rows. In FIG. 7, the rows of pixels in each pixel group may not be adjacent. In this example, the odd rows of pixels are included in the first pixel group, and the even rows of pixels are included in the second pixel group. As understood from the above-mentioned examples, the array of pixels may be divided into pixel groups in various ways, as long as each pixel group includes one or more rows of pixels. It is also understood that the array of pixels is not physically divided, but instead, is logically divided into pixel groups, so that each row of pixels may be scanned according to novel row/group scanning sequences as described below in detail.

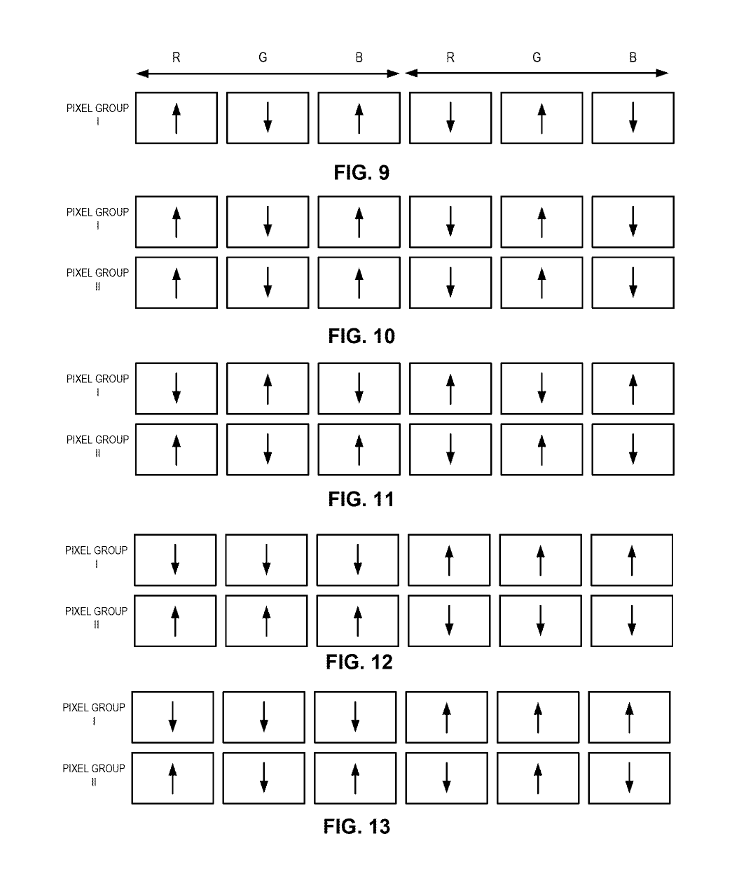

In this example, the control logic 104 of the display 101 is a TCON 302, and the driving units 103 include a scan driving unit 304, a data driving unit 306, and a backlight driving unit 308. The TCON 302 is configured to, based on received display data 106, provide a scan control signal Ss, a data control signal Sd, and a backlight control signal Sb to the scan driving unit 304, data driving unit 306, and backlight driving unit 308, respectively. The scan driving unit 304 in this example applies scan driving signals S1-Sn, which are generated based on the scan control signal Ss, to the scan lines for each row of pixels according to novel row/group scanning sequences in one time period (e.g., a sub frame for FSC LCDs). As mentioned above, the scan driving signals S1-Sn are applied to the gate electrode of each TFT to turn on the corresponding TFT by applying a gate voltage so that the data for the corresponding pixel may be written by the data driving unit 306. The scan driving unit 304 in this example may include a digital-analog converter (DAC) and multiplexers (MUX) for converting the digital scan control signal Ss to analog scan driving signals S1-Sn and applying the scan driving signals S1-Sn to the scan lines of each row of pixels according to the preset row/group scanning sequences. The novel row/group scanning sequences are described below in detail with respect to FIGS. 9-15.

The data driving unit 306 in this example is configured to write the display data into the array of pixels based on the data control signals Sd in each time period. For example, data driving units 306 may simultaneously apply data driving signals D1-Dn to the data lines for column of pixels. That is, the data driving units 306 may include a DAC, MUX, and arithmetic circuit for controlling a timing of application of voltage to the source electrode of each TFT and a magnitude of the applied voltage according to gradations of display data based on the data control signal Sd. The backlight driving unit 308 in this example is configured to sequentially apply a plurality of backlights having different colors to the array of pixels in a plurality of time periods (e.g., sub frames for FSC LCDs) based on the backlight control signal Sb. In this example, the R, G, and B LED light sources 212, 214, 216 may be sequentially turned on at the end of each time period by the backlight driving unit 308. As mentioned above, different and/or more light sources, such as C, M, Y, or W LEDs, may be included in other examples.

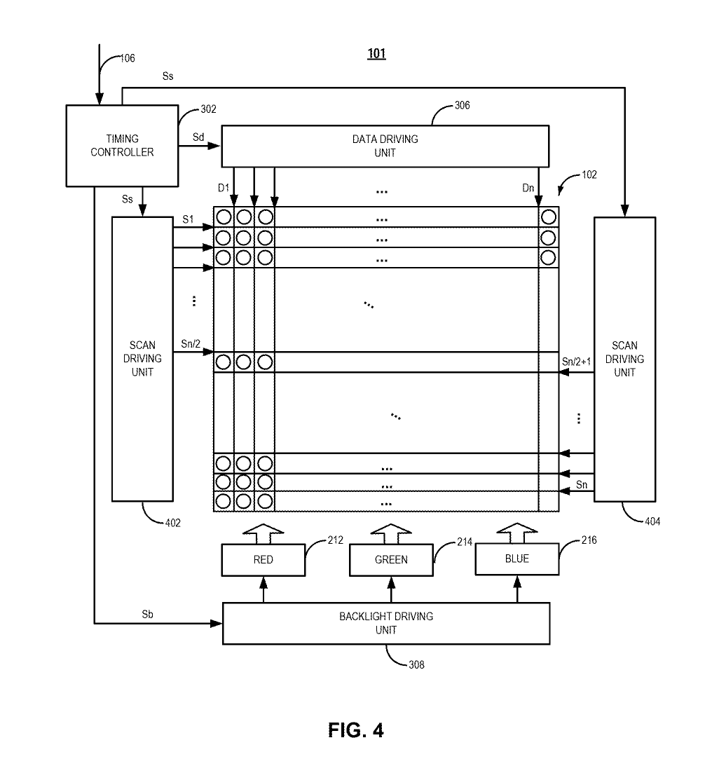

FIG. 4 is a plan-view diagram of another example of the display 101. FIG. 4 is similar to the example as described with respect to FIG. 3 except that FIG. 4 includes two scan driving units 402, 404. As mentioned above, the array of pixels on the display panel 102 may be divided into two or more pixel groups, each of which includes one or more rows of pixels. In this example, each scan driving unit 402, 404 is responsible for driving the rows of pixels in each pixel group. For example, the first scan driving unit 402 may apply scan driving signals S1-Sn/2 to the scan lines of the top-half rows of pixels (first pixel group), and the second scan driving unit 404 may apply scan driving signals Sn/2+1-Sn to the scan lines of the bottom-half rows of pixels (second pixel group). In this example, the two scan driving units 402, 404 may simultaneously scan the first and second pixel groups. It is understood that more than two scan driving units may be included in other examples to simultaneously scan different pixel groups.

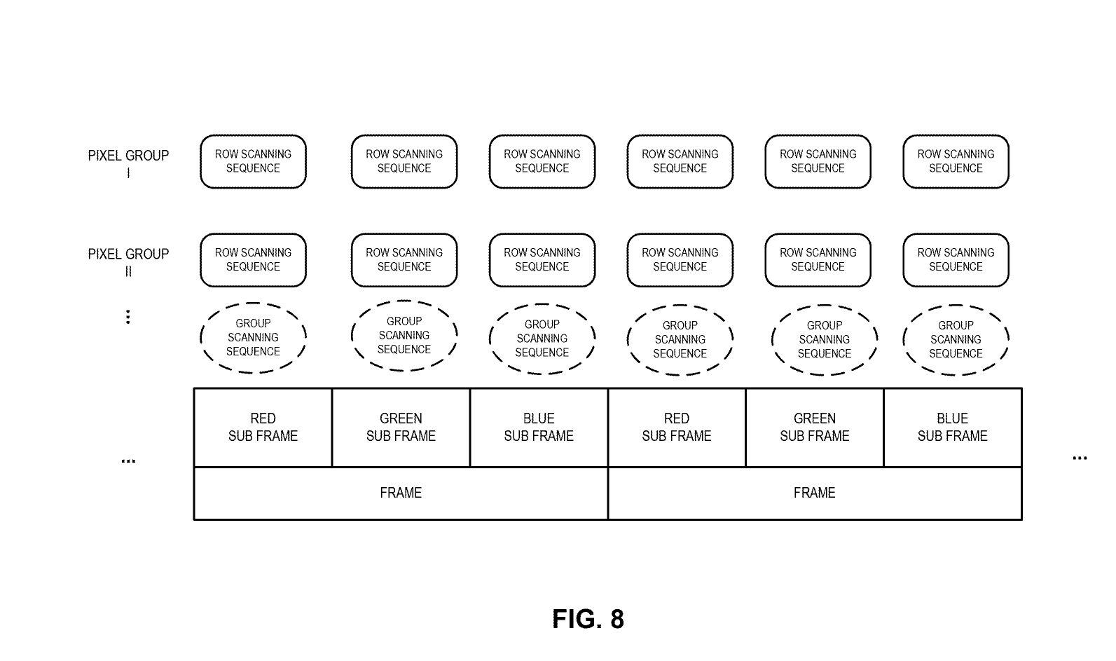

FIG. 8 is a depiction of a plurality of pixel groups scanned according to row/group scanning sequences in a plurality of sub frames. The display data 106 is received in successive frames at a frame rate, such as 30, 60, or 72 Hz. For FSC displays, each frame is further evenly divided into multiple time periods (sub frames, fields). For a FSC with three primary colors, i.e., R, G, and B, the field rate is three times of the frame rate. In this example, R, G, and B sub frames are repeated in this sequence. As mentioned above, the array of pixels on the display panel 102 may be divided into one or more pixel groups, each of which includes one or more rows of pixels. The rows of pixels in each pixel group are scanned by the scan driving unit 304, 402, 404 according to a row scanning sequence in one sub frame. In one example, the row scanning sequence is from top to bottom. That is, the scan driving unit 304, 402, 404 first applies the scan driving signal, e.g., voltage, to the gate electrodes of all TFTs in the top row of pixels through the corresponding scan line. The display data 106 then may be simultaneously written to each pixel of the top row by the data driving unit 306 through parallel data lines. The LC of each pixel of the top row is then set to the desired state based on the written data, e.g., magnitude of voltage signals. The scan driving unit 304, 402, 404 then scans the next row of pixels, i.e., the next row below the top row, according to the scanning sequence (from top to bottom) in this example. The process is then repeated until the last row of pixels in the pixel group (the bottom row of pixels) is scanned. In another example, the row scanning sequence is from bottom to top. In the same vein, the bottom row of pixels in the pixel group in first scanned, and the top row of pixels is scanned lastly. As shown in FIG. 8, the row scanning sequence for each pixel group is independent of each other. That is, each pixel group is scanned according to its own row scanning sequence. The different pixel groups may have the same row scanning sequence or different row scanning sequences.

Since there may be more than one pixel group, the sequence of scanning the multiple pixel groups may also needs to be specified according to a group scanning sequence if they are not simultaneously scanned, for example, by multiple scan driving units 402, 404. For example, if there are two pixel groups, in which the first pixel group includes the top-half rows of pixels and the second pixel group includes the bottom-half rows of pixels, the first pixel group may be scanned first or the second pixel group may be scanned first. If the group scanning sequence in this example is from the top pixel group to the bottom pixel group, then the top-half rows of pixels are scanned first according to its row scanning sequence. Once all the rows in the first pixel group have been scanned, the second pixel group is scanned. Accordingly, as shown in FIG. 8, the row scanning sequence for each pixel group combined with the group scanning sequence may define the sequence of scanning all the rows of pixels on the display panel 102 in one sub frame. It is understood that if there is more than one scan driving unit is applied as shown in FIG. 4, then the group scanning sequence may not be necessary as all the pixel groups may be individually driven by a corresponding scan driving unit and scanned simultaneously.

For each pixel group, the rows of pixels are scanned according to a second row scanning sequence in a second time period, e.g., sub frame. The second row scanning sequence may be the same as the first row scanning sequence in the first time period, or they may be different. Similarly, the group scanning sequence for all the pixel groups in the second sub frame may be the same as that in the first sub frame, or they may be different. Accordingly, the sequence of scanning all the rows of pixels on the display panel 102 may change in different sub frames. By defining the different sequence of scanning all the rows of pixels on the display panel 102 using the row/group scanning sequences, the one or more rows of pixels that are scanned at the end of each sub frame are not fixed as by the known solutions, thereby suppressing color breakup happened at those rows of pixels caused by limited LC setting speed in each sub frame.

FIGS. 9-13 are depictions of row scanning sequences for scanning rows of pixels in each pixel group in accordance with different embodiments set forth in the disclosure. In those examples, the row scanning sequence is either from top to bottom (↓) or from bottom to top (↑). That is, the first and second scanning sequences are opposite to each other in the vertical direction. Three sub frames, R, G, and B sub frames are included in each frame. In FIG. 1, there is only one pixel group on the display panel 102. The row scanning sequence changes between two adjacent sub frames. That is, the row scanning sequence of all the rows of pixels in a first time period is different from that in a second time period immediately after the first time period. In FIG. 9, in the first R sub frame, the top row of pixels is scanned at the end of the sub frame; in the adjacent G sub frame, the bottom row of pixels is lastly scanned. It is also noted that in this example, as there is an odd number of sub frames in each frame, i.e., three sub frames, the row scanning sequence of each sub frame with same backlight color (e.g., R sub frames) also changes between adjacent frames. For example, the row scanning sequence in the first R sub frame is ↑ while the row scanning sequence in the second R sub frame changes to ↓. That is, in this example, the row scanning sequence for all the rows of pixels changes between two adjacent sub frames and also changes between two adjacent frames. Accordingly, color breakup happened at the one or more rows of pixels that are scanned at the end of a sub frame is further suppressed. However, if each frame includes an even number of sub frames, e.g., four sub frames, then the row scanning sequence only changes between two adjacent sub frames but is kept the same between two adjacent frames.

In FIGS. 10-13, the array of pixels is divided into two pixel groups. As described above with respect to FIGS. 6-7, the array of pixels may be divided in various ways. In FIG. 10, for each pixel group, the row scanning sequence changes between two adjacent sub frames and also changes between two adjacent frames. In this example, in each sub frame, the pixel groups have the same scanning sequence. For example, in the first R sub frames, the row scanning sequence for both the first and second pixel groups is ↑. That is, the scan driving unit 304, 402, 404 is configured to, in each time period, scan the one or more rows of pixels according to a same row scanning sequence for each pixel group.

In FIG. 11, similarly, for each pixel group, the row scanning sequence changes between two adjacent sub frames and also changes between two adjacent frames. Different from the example of FIG. 10, in this example, in each sub frame, different pixel groups have different scanning sequences. For example, in the first R sub frames, the row scanning sequence for the first pixel group is ↓, while the row scanning sequence for the second pixel groups is ↑. That is, the scan driving unit 304, 402, 404 is configured to, in each time period, scan the one or more rows of pixels according to at least two row scanning sequences that are different from each other. If there are more than two pixel groups, in each time period, at least one of the pixel groups is scanned according to a first row scanning sequence, while the rows of pixels in the rest of the pixel groups are scanned according to a second row scanning sequence that is different from the first row scanning sequence.

In FIG. 12, the row scanning sequence for each pixel group does not change between two adjacent sub frames as in the examples of FIGS. 9-11. The row scanning sequence for each pixel group in one frame is kept the same. The row scanning sequence for each pixel group, however, changes between the two adjacent frames. For example, the row scanning sequence of the first pixel group is ↓ in all three sub frames of the first frame and changes to ↑ in all three sub frames of the adjacent second frame. The same pattern is applied to the second pixel group in which a different row scanning sequence is applied. It is understood that in other examples, the row scanning sequence for both the first and second pixels groups may be the same, which is kept the same in one frame and changes in the frame that is immediately after.

In FIG. 13, the row scanning sequence for one of the pixel groups follows the same pattern as shown in FIG. 12, while the row scanning sequence for the other pixel group follows the same pattern as shown in FIGS. 9-11. For example, the row scanning sequence of the first pixel group changes between two adjacent sub frames, while the row scanning sequence of the second pixel group is kept the same in one frame and changes between two adjacent frames. It is understood that FIGS. 9-13 are provided for an exemplary purpose only and without limitations. Any other row scanning sequence for one or more pixel groups may be derived from one or more of the examples illustrated in FIGS. 9-13.

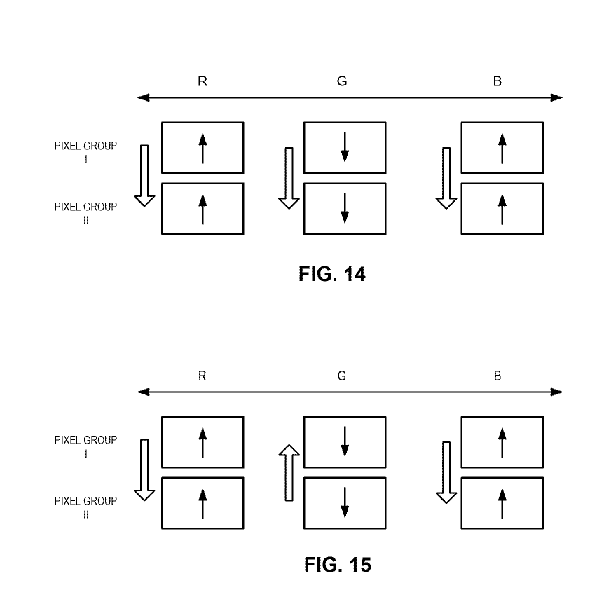

FIGS. 14-15 are depictions of group scanning sequences for scanning pixel groups in accordance with different embodiments set forth in the disclosure. In FIG. 14, the same group scanning sequence is always applied in different sub frames by the scan driving unit 304 to scan the first and second pixel groups. That is, the scan driving unit 304 is configured to sequentially scan the one or more groups of pixels according to a same group scanning sequence in the first and second time periods. For example, the scan driving unit 304 may always scan the rows of pixels in the first pixel group and then scan the rows of pixel in the second pixel group. In FIG. 15, the group scanning sequence changes between two adjacent sub frames. That is, in the first time period, the scan driving unit 304 is configured to sequentially scan the one or more groups of pixels according to a first group scanning sequence; in the second period, the scan driving unit 304 is configured to sequentially scan the one or more groups of pixels according to a second group scanning sequence that is different from the first group scanning sequence. As the group scanning sequence is set independent of the row scanning sequence, the row scanning sequence for each pixel group in FIGS. 14-15 is not limited and may be any suitable row scanning sequences as described above with respect to FIGS. 9-13. As noted above, if there are multiple scan driving units, the group scanning sequence may not be necessary as the scan driving units may simultaneously scan the rows of pixels in each pixel group.

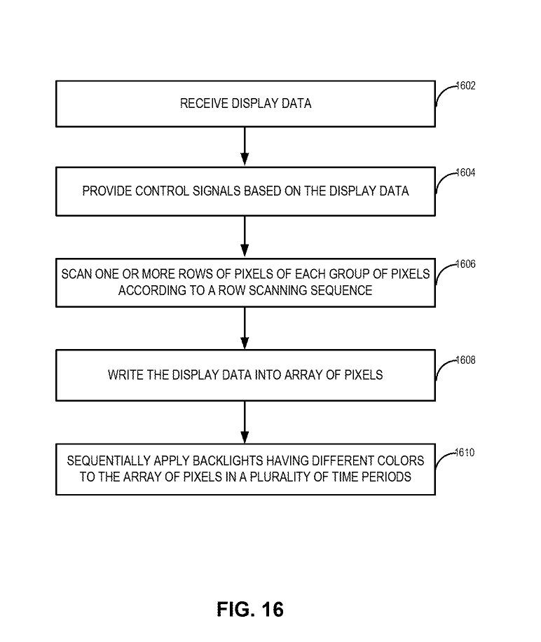

FIG. 16 depicts one example of a method for driving the display 101. It will be described with reference to the above figures. However, any suitable logic, units, or circuits may be employed. Beginning at block 1602, display data is received. For example, display data includes, for each pixel for display, primary color information, e.g., R, G, and B, to be displayed in successive sub frames. At block 1604, control signals are provided based on display data. The control signals may include a scan control signal, a data control signal, and a backlight control signal. As described above, blocks 1602, 1604 may be performed by the control logic 104 of the display 101, such as the TCON 302. Proceeding to block 1606, the one or more rows of pixels of each group of pixels are scanned according to a row scanning sequence based on the control signals. The row scanning sequence includes any row scanning sequence disclosed in FIGS. 9-13. For each group of pixels, in a first time period, the one or more rows of pixels are sequentially scanned according to a first row scanning sequence; in a second time period, the one or more rows of pixels are sequentially scanned according to a second row scanning sequence. As described above, this may be performed by the scan driving unit 304, 402, 404 of the display 101. At bock 1608, the display data is written into the array of pixels based on the control signals. As described above, this may be performed by the data driving unit 306 of the display 101. Moving to block 1610, a plurality of backlights having different colors are applied to the array of pixels in a plurality of time periods based on the control signals. As described above, this may be performed by the backlight driving unit 308 of the display 101.

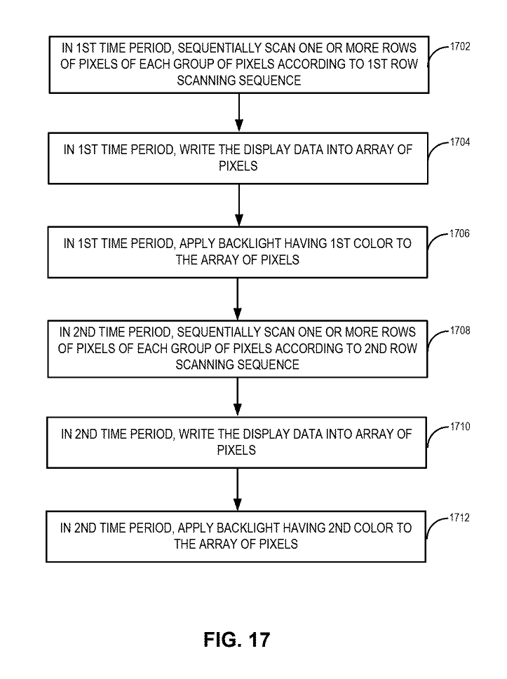

FIG. 17 depicts another example of a method for driving the display 101. It will be described with reference to the above figures. However, any suitable logic, units, or circuits may be employed. Beginning at block 1702, in a first time period, e.g., a sub frame for FSC displays, one or more rows of pixels of each group of pixels are sequentially scanned according to a first row scanning sequence. In the same first time period, at block 1704, the display data is written into the array of pixels on the display panel 102. At block 1706, in the same first time period, backlight having a first color is applied to the array of pixels. In the second time period, e.g., another sub frame, at block 1708, the one or more rows of pixels of each group of pixels are sequentially scanned according to a second row scanning sequence. In the same second time period, at block 1710, the display data is written into the array of pixels on the display panel 102. At block 1712, in the same second time period, backlight having a second color is applied to the array of pixels. As described above, blocks 1702, 1708 may be performed by the scan driving unit 304, 402, 404 of the display 101, blocks 1704, 1710 may be performed by the data driving unit 306 of the display 101, and blocks 1706, 1712 may be performed by the backlight driving unit 308 of the display 101.

In this example, the first and second row scanning sequences are different from each other. If the first and second time periods are adjacent to each other, i.e., the second time period is immediately after the first time period, then the row scanning sequence for each pixel group changes between two adjacent time periods. The first and second time periods may be not adjacent to each other. In this case, the row scanning sequence for each pixel group at least changes once in the plurality of time periods. In an extreme example, for n successive sub frames, the row scanning sequence for n−1 of the n sub frames is the same, while the row scanning sequence of one of the n sub frames is different. Accordingly, the row scanning sequences disclosed herein avoid the situation that the same row scanning sequence is always applied to the array of pixels in all the sub frames, which causes color breakup at the one or more rows of pixels that are scanned at the end of each sub frame due to limited LC setting speed in FSC LCDs.

Aspects of the method for driving a display, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Also, integrated circuit design systems (e.g. work stations) are known that create wafers with integrated circuits based on executable instructions stored on a computer readable medium such as but not limited to CDROM, RAM, other forms of ROM, hard drives, distributed memory, etc. The instructions may be represented by any suitable language such as but not limited to hardware descriptor language (HDL), Verilog or other suitable language. As such, the logic, units, and circuits described herein may also be produced as integrated circuits by such systems using the computer readable medium with instructions stored therein. For example, an integrated circuit with the aforedescribed logic, units, and circuits may be created using such integrated circuit fabrication systems. The computer readable medium stores instructions executable by one or more integrated circuit design systems that causes the one or more integrated circuit design systems to design an integrated circuit. The designed integrated circuit includes control logic and a scan driving unit. The control logic is configured to control driving of a display panel having an array of pixels divided into one or more groups of pixels. Each group of pixels includes one or more rows of pixels. The control logic is also configured to control sequentially applying of a plurality of backlights having different colors to the array of pixels in a plurality of time periods. The scan driving unit is operatively coupled to the control logic and is configured to, in each time period, scan the one or more rows of pixels of each group of pixels according to a row scanning sequence. For each group of pixels, in a first time period, the scan driving unit sequentially scans the one or more rows of pixels according to a first row scanning sequence; in a second time period, the scan driving unit sequentially scans the one or more rows of pixels according to a second row scanning sequence.

The above detailed description of the disclosure and the examples described therein have been presented for the purposes of illustration and description only and not by limitation. It is therefore contemplated that the present disclosure cover any and all modifications, variations or equivalents that fall within the spirit and scope of the basic underlying principles disclosed above and claimed herein.

What is claimed is:

1. An apparatus comprising:
control logic configured to:
control driving of a display panel having an array of pixels divided into one or more groups of pixels, each group of pixels including one or more rows of pixels, and
control sequentially applying of a plurality of backlights having different colors to the array of pixels in a plurality of time periods; and
a scan driving unit operatively coupled to the control logic and configured to, in each time period, scan the one or more rows of pixels of each group of pixels according to a row scanning sequence, wherein,
for each group of pixels,
in a first time period, the scan driving unit sequentially scans the one or more rows of pixels according to a first row scanning sequence, and
in a second time period, the scan driving unit sequentially scans the one or more rows of pixels according to a second row scanning sequence.

2. The apparatus of claim 1, wherein the first and second row scanning sequences are opposite to each other in a vertical direction.

3. The apparatus of claim 1, wherein the second time period is immediately after the first time period.

4. The apparatus of claim 1, wherein the scan driving unit is configured to, in each time period, scan the one or more rows of pixels according to a same row scanning sequence for each group of pixels.

5. The apparatus of claim 1, wherein the scan driving unit is configured to, in each time period, scan the one or more rows of pixels according to the first row scanning sequence for at least one group of pixels and scan the one or more rows of pixels according to the second scanning sequence for the rest of groups of pixels.

6. The apparatus of claim 1, wherein the scan driving unit is configured to, in each time period, simultaneously scan the one or more groups of pixels.

7. The apparatus of claim 6, further comprising a plurality of scan driving units,
wherein, in each time period, each scan driving unit simultaneously scans at least one group of pixels.

8. The apparatus of claim 1, wherein the scan driving unit is further configured to sequentially scan the one or more groups of pixels according to a same group scanning sequence in the first and second time periods.

9. The apparatus of claim 1, wherein the scan driving unit is further configured to:
in the first time period, sequentially scan the one or more groups of pixels according to a first group scanning sequence; and
in the second time period, sequentially scan the one or more groups of pixels according to a second group scanning sequence.

10. The apparatus of claim 1, further comprising a backlight driving unit operatively coupled to the control logic and configured to sequentially apply a red light, a green light, and a blue light to the array of pixels in three sub frames of a frame.

11. The apparatus of claim 10, wherein the row scanning sequence for each group of pixels changes between two adjacent sub frames.

12. The apparatus of claim 10, wherein the row scanning sequence for each group of pixels changes between two adjacent frames.

13. An apparatus comprising:
a display panel having an array of pixels divided into one or more groups of pixels, each group of pixels including one or more rows of pixels;
control logic configured to receive display data and provide control signals based on the display data;
a backlight driving unit operatively coupled to the control logic and configured to sequentially apply a plurality of backlights having different colors to the array of pixels in a plurality of time periods based on the control signals; and
a scan driving unit operatively coupled to the control logic and configured to, in each time period, scan the one or more rows of pixels of each group of pixels according to a row scanning sequence based on the control signals; and
a data driving unit operatively coupled to the control logic and configured to, in each time period, write the display data into the array of pixels based on the control signals, wherein,
for each group of pixels,
in a first time period, the scan driving unit sequentially scans the one or more rows of pixels according to a first row scanning sequence, and
in a second time period, the scan driving unit sequentially scans the one or more rows of pixels according to a second row scanning sequence.

14. The apparatus of claim 13, wherein the first and second row scanning sequences are opposite to each other in a vertical direction.

15. The apparatus of claim 13, wherein the second time period is immediately after the first time period.

16. The apparatus of claim 13, wherein the scan driving unit is configured to, in each time period, scan the one or more rows of pixels according to a same row scanning sequence for each group of pixels.

17. The apparatus of claim 13, wherein the scan driving unit is configured to, in each time period, scan the one or more rows of pixels according to the first row scanning sequence for at least one group of pixels and scan the one or more rows of pixels according to the second scanning sequence for the rest of groups of pixels.

18. The apparatus of claim 13, wherein the scan driving unit is configured to, in each time period, simultaneously scan the one or more groups of pixels.

19. The apparatus of claim 18, further comprising a plurality of scan driving units,
wherein, in each time period, each scan driving unit simultaneously scans at least one group of pixels.

20. The apparatus of claim 13, wherein the scan driving unit is further configured to sequentially scan the one or more groups of pixels according to a same group scanning sequence in the first and second time periods.

21. The apparatus of claim 13, wherein the scan driving unit is configured to:
in the first time period, sequentially scan the one or more groups of pixels according to a first group scanning sequence; and
in the second time period, sequentially scan the one or more groups of pixels according to a second group scanning sequence.

22. The apparatus of claim 13, wherein the backlight driving unit is configured to sequentially apply a red light, a green light, and a blue light to the array of pixels in three sub frames of a frame.

23. The apparatus of claim 22, wherein the row scanning sequence for each group of pixels changes between two adjacent sub frames.

24. The apparatus of claim 22, wherein the row scanning sequence for each group of pixels changes between two adjacent frames.

25. The apparatus of claim 13, further comprising:
a processor configured to generate the display data; and
a memory operatively coupled to the processor and the control logic, configured to store the display data.

26. The apparatus of claim 13, further comprising a receiver operatively coupled to the control logic, configured to receive the display data and provide the display data to the control logic.

27. A method for driving a display panel having an array of pixels divided into one or more groups of pixels, each group of pixels including one or more rows of pixels, the method comprising:
receiving display data;
providing control signals based on the display data;
scanning the one or more rows of pixels of each group of pixels according to a row scanning sequence based on the control signals;
writing the display data into the array of pixels based on the control signals; and
sequentially applying a plurality of backlights having different colors to the array of pixels in a plurality of time periods based on the control signals, wherein,
for each group of pixels,
in a first time period, the one or more rows of pixels are sequentially scanned according to a first row scanning sequence, and
in a second time period, the one or more rows of pixels are sequentially scanned according to a second row scanning sequence.

28. The method of claim 27, wherein the first and second row scanning sequences are opposite to each other in a vertical direction.

29. The method of claim 27, wherein the second time period is immediately after the first time period.

30. The method of claim 27, wherein, in each time period, the one or more rows of pixels are scanned according to a same row scanning sequence for each group of pixels.

31. The method of claim 27, wherein, in each time period, the one or more rows of pixels are scanned according to the first row scanning sequence for at least one group of pixels and are scanned according to the second row scanning sequence for the rest of groups of pixels.

32. The method of claim 27, wherein, in each time period, the one or more groups of pixels are simultaneously scanned.

33. The method of claim 27, wherein the one or more groups of pixels are sequentially scanned according to a same group scanning sequence in the first and second time periods.

34. The method of claim 27, wherein,
in the first time period, the one or more groups of pixels are sequentially scanned according to a first group scanning sequence; and
in the second time period, the one or more groups of pixels are sequentially scanned according to a second group scanning sequence.

35. The method of claim 27, wherein applying a plurality of backlights comprises sequentially applying a red light, a green light, and a blue light to the array of pixels in three sub frames of a frame.

36. The method of claim 35, wherein the row scanning sequence for each group of pixels changes between two adjacent sub frames.

37. The method of claim 35, wherein the row scanning sequence for each group of pixels changes between two adjacent frames.
